(19) United States
(12) Patent Application Publication
(10) Pub. No.: US 2026/0367473 A1
(43) Pub. Date: Nov. 19, 2026

(54) OPTICAL SWITCHING DEVICES WITH A COMMON HEATER

(71) Applicant: GlobalFoundries U.S. Inc., Malta, NY (US)

(72) Inventors: Aneesh Dash, Bangalore (IN); Kevin K. Dezfulian, Arlington, VA (US)

(21) Appl. No.: 19/207,518

(22) Filed: May 14, 2025

(51) Int. Cl. G02F 1/313

(52) U.S. Cl. CPC G02F 1/3136

(57) ABSTRACT

Structures for an optical switching device and methods of forming a structure for an optical switching device. The structure comprises a first Mach-Zehnder interferometer including a first delay arm and a second Mach-Zehnder interferometer including a second delay arm. The first delay has a section, and the second delay arm has a section adjacent to the section of the first delay arm. The structure further comprises a phase shifter coupled to the section of the first delay arm of the first Mach-Zehnder interferometer and the section of the second delay arm of the second Mach-Zehnder interferometer.

### BACKGROUND

The disclosure relates to photonic chips and, more specifically, to structures for an optical switching device and methods of forming a structure for an optical switching device.

Photonic chips are used in many applications and systems including, but not limited to, data communication systems and data computation systems. A photonic chip includes a photonic integrated circuit comprised of photonic components, such as modulators, polarizers, and optical couplers, that are used to manipulate light received from a light source, such as a laser or an optical fiber.

An optical switching device is a common photonic component that may be found in a photonic integrated circuit. A Mach-Zehnder interferometer can be used as a base device for an optical switching device. An optical coupler splits input light between a pair of arms of the Mach-Zehnder interferometer. A phase difference may be introduced between the light propagating in the different arms to provide a pair of different switched conditions. The arms converge at a downstream optical coupler at which the light is combined. In one switched condition, the phase difference between the light after propagating through the arms is an odd multiple of pi, and the combined light exits from an output port of the output coupler. In the other switched condition, the phase difference between the light after propagating through the arms is an even multiple of pi, and the combined light exits from a different output port of the output coupler.

Conventional optical switching devices based on a Mach-Zehnder interferometer may be characterized by a high insertion loss that is unacceptable in certain applications or systems. Conventional optical switching devices based on a Mach-Zehnder interferometer may also suffer from a low extinction ratio. Mach-Zehnder interferometers that utilize a thermo-optic phase shifter are characterized by an excessively-large footprint, which is needed to prevent thermal crosstalk.

Improved structures for an optical switching device and methods of forming a structure for an optical switching device are needed.

### SUMMARY

In an embodiment of the invention, a structure comprises a first Mach-Zehnder interferometer including a first delay arm and a second Mach-Zehnder interferometer including a second delay arm. The first delay has a section, and the second delay arm has a section adjacent to the section of the first delay arm. The structure further comprises a phase shifter coupled to the section of the first delay arm of the first Mach-Zehnder interferometer and the section of the second delay arm of the second Mach-Zehnder interferometer.

In an embodiment of the invention, a structure comprises a Mach-Zehnder interferometer including a delay arm and a micro-ring resonator including a waveguide core adjacent to a section of the delay arm. The structure further comprises a phase shifter coupled to the section of the delay arm and a portion of the waveguide core of the micro-ring resonator.

In an embodiment of the invention, a method comprises forming a first Mach-Zehnder interferometer including a first delay arm, forming a second Mach-Zehnder interferometer including a second delay arm, and forming a phase shifter coupled to a section of the first delay arm of the first Mach-Zehnder interferometer and a section of the second delay arm of the second Mach-Zehnder interferometer that is adjacent to the section of the first delay arm.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure for an optical switching device at an initial fabrication stage of a processing method in accordance with embodiments of the invention.

FIG. 2 is a cross-sectional view of the structure taken generally along line 2-2 in FIG. 1.

FIG. 3 is a top view of a structure at a fabrication stage subsequent to FIGS. 1, 2.

FIG. 4 is a cross-sectional view of the structure taken generally along line 4-4 in FIG. 3.

FIG. 5 is a cross-sectional view of the structure at a fabrication stage subsequent to FIGS. 3, 4.

FIG. 6 is a cross-sectional view of a structure in accordance with alternative embodiments of the invention.

FIG. 7 is a cross-sectional view of a structure in accordance with alternative embodiments of the invention.

FIG. 8 is a top view of a structure for an optical switching device at an initial fabrication stage of a processing method in accordance with embodiments of the invention.

FIG. 9 is a cross-sectional view of the structure taken generally along line 9-9 in FIG. 8.

FIG. 10 is a cross-sectional view of the structure at a fabrication stage subsequent to FIGS. 8, 9.

FIG. 11 is a top view of a structure in accordance with alternative embodiments of the invention.

FIG. 12 is a top view of a structure in accordance with alternative embodiments of the invention.

FIG. 13 is a diagrammatic view of a structure in accordance with alternative embodiments of the invention.

### DETAILED DESCRIPTION

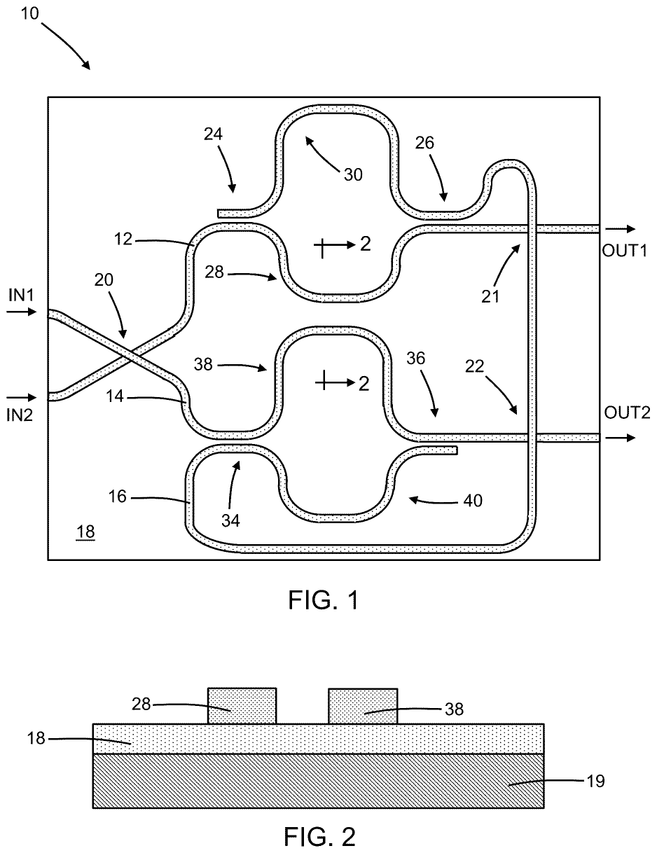

With reference to FIGS. 1, 2 and in accordance with embodiments of the invention, a structure 10 for an optical switching device includes a waveguide core 12, a waveguide core 14, and a waveguide core 16 that are positioned on, and overlie, a dielectric layer 18 and a semiconductor substrate 19. In an embodiment, the dielectric layer 18 may be comprised of a dielectric material, such as silicon oxide (e.g., silicon dioxide), and the semiconductor substrate 19 may be comprised of a semiconductor material, such as single-crystal silicon. In an embodiment, the dielectric layer 18 may be a buried oxide layer of a silicon-on-insulator substrate. The dielectric layer 18 is arranged in a vertical direction between the waveguide cores 12, 14, 16 and the semiconductor substrate 19. The dielectric layer 18 may provide low-index cladding that optically isolates the waveguide cores 12, 14, 16 from the semiconductor substrate 19.

The waveguide core 12 and the waveguide core 16 are routed to include adjacent sections that represent a directional coupler 24 of a Mach-Zehnder interferometer and adjacent sections that represent a directional coupler 26 of the Mach-Zehnder interferometer. The waveguide core 12 includes a delay arm 28 of the Mach-Zehnder interferometer that is arranged along the length of the waveguide core 12 between the directional couplers 24, 26, and the waveguide core 16 includes a delay arm 30 of the Mach-Zehnder interferometer that is arranged along the length of the waveguide core 16 between the directional couplers 24, 26.

The delay arm 28 is coupled to the section of the waveguide core 12 participating in the directional coupler 24 and is also coupled to the section of the waveguide core 12 participating in the directional coupler 26. The delay arm 30 is coupled to the section of the waveguide core 16 participating in the directional coupler 24 and is also coupled to the section of the waveguide core 16 participating in the directional coupler 26. The directional coupler 24 has a coupling length over which the participating section of the waveguide cores 12 and the participating section of the waveguide core 16 have a spacing that permits light coupling. Similarly, the directional coupler 26 has a coupling length over which the participating section of the waveguide core 12 and the participating section of the waveguide core 16 have a spacing that permits light coupling. In an alternative embodiment, the directional couplers 24, 26 may be replaced by a different type of optical coupler, such as a multi-mode interference coupler, a Y-junction coupler, or a trident coupler, that is capable of splitting or combining light.

The waveguide core 14 and the waveguide core 16 are routed to include adjacent sections that represent a directional coupler 34 of a Mach-Zehnder interferometer and adjacent sections that represent a directional coupler 36 of the Mach-Zehnder interferometer. The waveguide core 14 includes a delay arm 38 of the Mach-Zehnder interferometer that is arranged along the length of the waveguide core 14 between the directional couplers 34, 36, and the waveguide core 16 includes a delay arm 40 of the Mach-Zehnder interferometer that is arranged along the length of the waveguide core 16 between the directional couplers 34, 36.

The delay arm 38 is coupled to the section of the waveguide core 14 participating in the directional coupler 34 and is also coupled to the section of the waveguide core 14 participating in the directional coupler 36. The delay arm 40 is coupled to the section of the waveguide core 16 participating in the directional coupler 34 and is also coupled to the section of the waveguide core 16 participating in the directional coupler 36. The directional coupler 34 has a coupling length over which the participating section of the waveguide core 14 and the participating section of the waveguide core 16 have a spacing that permits light coupling. Similarly, the directional coupler 36 has a coupling length over which the participating section of the waveguide core 14 and the participating section of the waveguide core 16 have a spacing that permits light coupling. In an alternative embodiment, the directional couplers 34, 36 may be replaced by a different type of optical coupler, such as a multi-mode interference coupler, a Y-junction coupler, or a trident coupler.

The waveguide core 12 and the waveguide core 14 are routed to intersect and cross at a waveguide crossing 20. The directional coupler 34 is arranged downstream in a direction of light propagation from the waveguide crossing 20. A section of the waveguide core 12 upstream from the waveguide crossing 20 may provide a light input IN1 to the structure 10. A section of the waveguide core 14 upstream in a direction of light propagation from the waveguide crossing 20 may provide a light input IN2 to the structure 10. The directional coupler 24 and the directional coupler 34 are arranged downstream from the waveguide crossing 20. The waveguide core 12 and the waveguide core 16 are routed to intersect and cross at a waveguide crossing 21. A section of the waveguide core 12 downstream from the waveguide crossing 21 may provide a light output OUT1 from the structure 10. The directional coupler 26 is arranged upstream from the waveguide crossing 21. The waveguide core 14 and the waveguide core 16 are routed to intersect and cross at a waveguide crossing 22. A section of the waveguide core 14 downstream from the waveguide crossing 22 may provide a light output OUT2 from the structure 10. The directional coupler 36 is arranged upstream from the waveguide crossing 22.

The delay arm 30 participating in the Mach-Zehnder interferometer that also includes the delay arm 28 may have a length along the direction of light propagation in the waveguide core 16 effective to introduce a difference in optical path length between the delay arms 28, 30 equal to pi (i.e., π). The delay arm 38 participating in the Mach-Zehnder interferometer that includes the delay arm 40 may have a length along the direction of light propagation in the waveguide core 16 effective to introduce a difference in optical path length between the delay arms 38, 40 equal to pi (i.e., π).

In an embodiment, the waveguide cores 12, 14, 16 may be comprised of a material having a refractive index that is greater than the refractive index of silicon dioxide. In an embodiment, the waveguide cores 12, 14, 16 may be comprised of a semiconductor material, such as single-crystal silicon. In an alternative embodiment, the waveguide cores 12, 14, 16 may be comprised of amorphous silicon or polycrystalline silicon. In an alternative embodiment, the waveguide cores 12, 14, 16 may be comprised of a dielectric material, such as silicon nitride. In an alternative embodiment, the waveguide cores 12, 14, 16 may be comprised of a different dielectric material, such as silicon oxynitride or aluminum nitride. In alternative embodiments, other materials, such as a polymer or a III-V compound semiconductor, may be used to form the waveguide cores 12, 14, 16.

In an embodiment, the waveguide cores 12, 14, 16 may be formed by patterning a layer of material with lithography and etching processes. In an embodiment, the waveguide cores 12, 14, 16 may be formed by patterning the semiconductor material (e.g., single-crystal silicon) of a device layer of a silicon-on-insulator substrate. In an alternative embodiment, the waveguide cores 12, 14, 16 may be formed by patterning a deposited layer of a material (e.g., silicon nitride). In an embodiment, the waveguide cores 12, 14, 16 may have a wire, rib, slot, or sandwich construction instead of the representative ridge construction. In embodiments, the bends included in the waveguide cores 12, 14, 16 may be circular bends, Euler bends, polynomial bends, or trigonometric bends that enable adiabatic, or approximately adiabatic, mode evolution of propagating light.

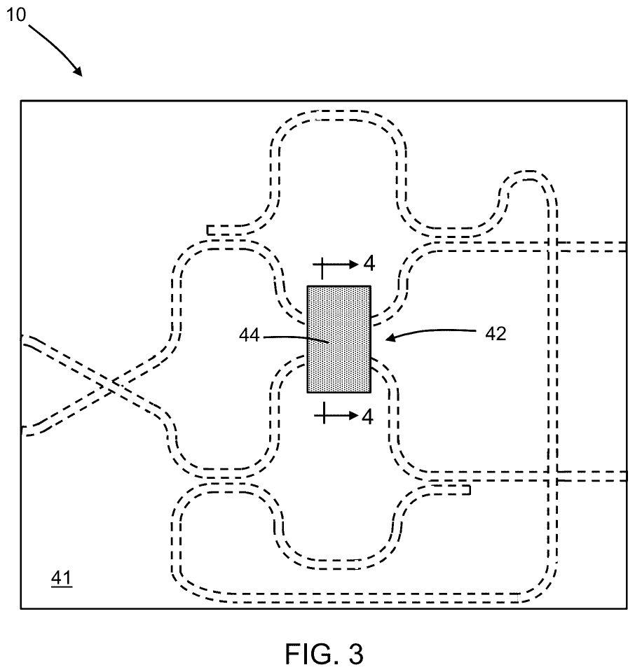

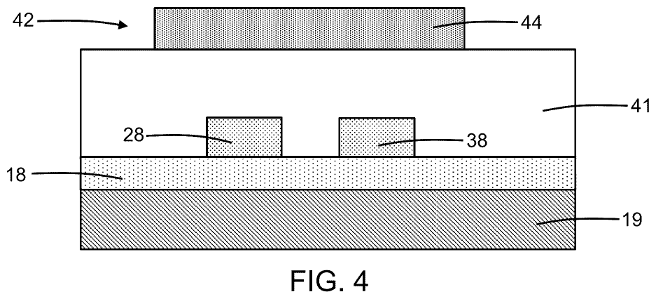

With reference to FIGS. 3, 4 and at a fabrication stage subsequent to FIGS. 1, 2, a dielectric layer 41 may be formed over the waveguide cores 12, 14, 16. In an embodiment, the dielectric layer 41 may be comprised of silicon oxide (e.g., silicon dioxide), and may be deposited and planarized.

The structure 10 may include a phase shifter 42 is coupled to a section of the delay arm 28 that is arranged along the length of the waveguide core 12 between the directional coupler 24 and the directional coupler 26. The phase shifter 42 is coupled to a section of the delay arm 38 that is arranged along the length of the waveguide core 14 between the directional coupler 34 and the directional coupler 36. The phase shifter 42, which is shared by, and common to, the delay arm 28 and the delay arm 38, is configured to shift the phase of light propagating in the section of the delay arm 28 and the section of the delay arm 38. The phase shifts may determine whether light received at the light input IN1 is output from the light output OUT1 and may also determine whether light received at the light input IN2 is output from the light output OUT2. The phase shifter 42 is laterally spaced from, and non-overlapping with, the delay arm 30 and the delay arm 40 such that the delay arms 30, 40 are not coupled to the phase shifter 42.

In an embodiment, the phase shifter 42 may be a thermo-optic phase shifter that includes a resistive heating element 44 positioned on the dielectric layer 41. In an embodiment, the resistive heating element 44 may be configured to generate heat by Joule heating under the control of a variable electrical signal. The resistive heating element 44 may be comprised of a metal, such as titanium nitride, and the resistive heating element 44 may be formed by depositing and patterning the metal.

The resistive heating element 44 overlies and overlaps with a section of the delay arm 28 and with a section of the delay arm 38. The sections of the delay arms 28, 38 overlapped by the resistive heating element 44 are coupled to the phase shifter 42. The resistive heating element 44 is laterally spaced from, and has a non-overlapping relationship with, the delay arm 30 and the delay arm 40. The waveguide crossing 20 routes the waveguide core 12 and the waveguide core 14 to enable the phase shifter 42 to be coupled to the section of the delay arm 28 underlying the resistive heating element 44 and also coupled to the section of the delay arm 38 adjacent to the section of the delay arm 28 underlying the resistive heating element 44. The coupled section of the delay arm 28 underlying the resistive heating element 44 and the adjacent coupled section of the delay arm 38 underlying the resistive heating element 44 may be laterally spaced apart such that crosstalk is negligible.

Heat may be transferred by thermal conduction from the resistive heating element 44 to the coupled section of the delay arm 28 of the waveguide core 12 underlying the resistive heating element 44 and the coupled section of the delay arm 38 of the waveguide core 14 underlying the resistive heating element 44. The temperature of the coupled section of the delay arm 28 and the coupled section of the delay arm 38 is locally elevated by the heat received from the resistive heating element 44. The delay arm 30 and the delay arm 40 are unheated by heat transferred from the resistive heating element 44 because of their spacing from the resistive heating element 44. The localized temperature variation experienced by the coupled section of the delay arm 28 and the coupled section of the delay arm 38 is effective to change the refractive index of their constituent material(s) through the thermo-optic effect and to thereby alter the phase of light propagating in the coupled section of the delay arm 28 and the coupled section of the delay arm 38. In an embodiment, the phase shifter 42 may be operated to provide a phase shift equal to zero (i.e., 0) or an integer multiple of pi, or a phase shift equal to one-half pi (i.e., π/2) or half-integer multiple of pi. The phase shift generated by the phase shifter 42 may offset the phase shift introduced by the optical path length difference between the delay arms 28, 30 to provide a total phase shift modulated between an integer multiple of pi or a half-integer multiple of pi, which switches the transmission of light from the light input IN1 to the light output OUT1. The phase shift generated by the phase shifter 42 may offset the phase shift introduced by the optical path length difference between the delay arms 38, 40 to provide a total phase shift modulated between an integer multiple of pi or a half-integer multiple of pi, which switches the transmission of light from the light input IN2 to the light output OUT2. In alternative embodiments, the phase shifter 42 may be replaced by an electro-optic phase shifter, a lithium niobate-based phase shifter, a barium titanate-based phase shifter, a polymer-based phase shifter, a two-dimensional material-based phase shifter, or a microelectromechanical system-based phase shifter.

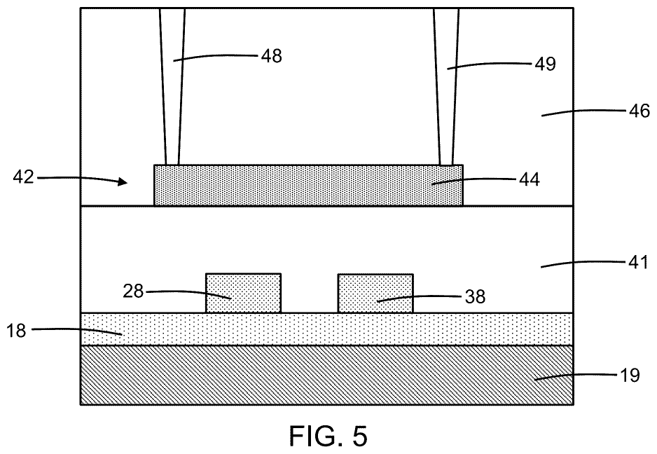

With reference to FIG. 5 in which like reference numerals refer to like features in FIGS. 3, 4 and at a subsequent fabrication stage, a dielectric layer 46 may be formed that overlies the resistive heating element 44 of the phase shifter 42. The dielectric layer 46 may be comprised of a dielectric material, such as silicon oxide (e.g., silicon dioxide).

Contacts 48, 49 may be formed in the dielectric layer 46 that are coupled to different portions of the resistive heating element 44. The contacts 48, 49 may be comprised of a metal, such as tungsten. The contacts 48, 49 may be used to supply a current to the resistive heating element 44 of the phase shifter 42 that causes Joule heating. Heat transferred from the resistive heating element 44 to the section of the delay arm 28 may be utilized to shift the phase of light propagating in the section of the delay arm 28 by modulating the refractive index of the material constituting the section of the delay arm 28. Heat transferred from the resistive heating element 44 to the section of the delay arm 38 may be utilized to shift the phase of light propagating in the section of the delay arm 38 by modulating the refractive index of the material constituting the section of the delay arm 38. The delay arm 30 and the delay arm 40 are thermally isolated by their spacing from the resistive heating element 44.

Light propagating in the section of the delay arm 28 may be tuned by the phase shifter 42 to have the same phase as light propagating in the section of the delay arm 38. The optical switching device embodied in the structure 10 is more area efficient than conventional optical switching devices because of the shared tuning by the phase shifter 42. Specifically, a clearance for thermal isolation between the delay arm 28 and the delay arm 38 of the different Mach-Zehnder interferometers is not required because, instead of separate phase shifters, the resistive heating element 44 of the phase shifter 42 commonly overlaps with the coupled section of the delay arm 28 and with the coupled section of the delay arm 38. The optical switching device embodied in the structure 10 may be more power efficient because the phase shifter 42 is common to, and shared by, the coupled section of the delay arm 28 and the coupled section of the delay arm 38.

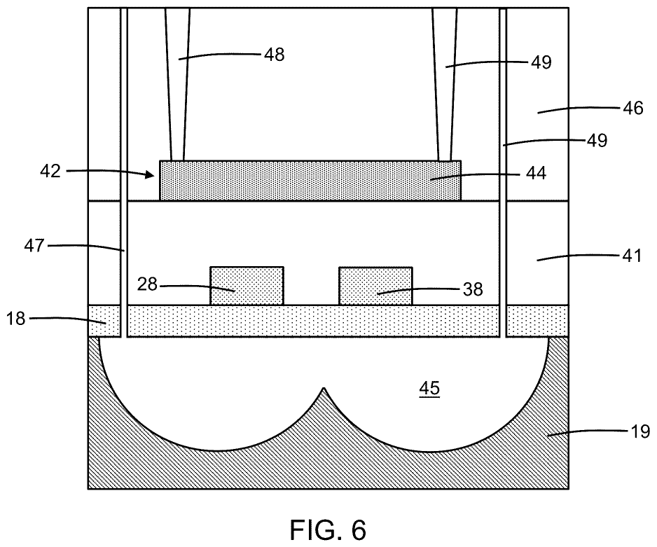

With reference to FIG. 6 and in accordance with alternative embodiments of the invention, the structure 10 may further include a cavity 45 in the semiconductor substrate 19. The cavity 45 may be formed by an isotropic etching process that includes a vertical etching component and a lateral etching component. In an embodiment, the coupled section of the delay arm 28 and the coupled section of the delay arm 38 between the cavity 45 and the phase shifter 42 with the cavity 45 may be arranged beneath the coupled sections of the delay arms 28, 38.

The cavity 45 may provide thermal isolation of the resistive heating element 44 from the bulk of the semiconductor substrate 19. In an embodiment, the cavity 45 may be filled by air or a different gas. In the representative embodiment, the cavity 45 may include a pair of interconnected chambers. In an alternative embodiment, the cavity 45 may include more than a pair of interconnected chambers.

The structure 10 may further include airgaps 47, 51 that extend through the dielectric layer 18, the dielectric layer 41, and the dielectric layer 46. The resistive heating element 44 may be laterally between the airgap 47 and the airgap 51. In an embodiment, the airgap 47 and the airgap 51 may be trenches that are patterned by lithography and etching processes. In an embodiment, the airgap 47 and the airgap 51 and, which may be filled by air or a different gas and not filled by solid dielectric material, may extend to the cavity 45. The airgap 47 and the airgap 51 may improve the thermal isolation of the delay arm 30 and the delay arm 40 from the resistive heating element 44.

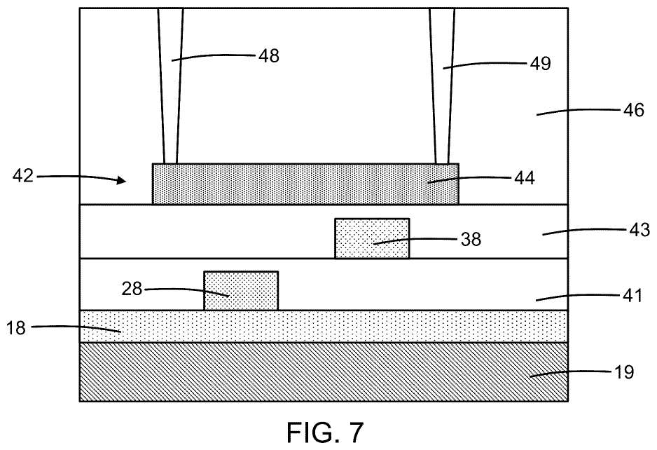

With reference to FIG. 7 and in accordance with alternative embodiments of the invention, the waveguide core 12, including the delay arms 28, 30, and the waveguide core 14, including the delay arms 38, 40, may be arranged in different horizontal planes rather being arranged in the same horizontal plane. For example, the waveguide core 14 may overlie the waveguide core 12 such that the delay arm 28 is arranged in a vertical direction between the delay arm 38 and both the dielectric layer 18 and the semiconductor substrate 19. In an embodiment, the waveguide core 12 and the waveguide core 14 may be comprised of different materials. The waveguide core 16 may be arranged in the same horizontal plane as the waveguide core 12 or the waveguide core 14. In an alternative embodiment, the waveguide core 16 may be arranged in a different horizontal plane than the waveguide core 12 and a different horizontal plane than the waveguide core 14.

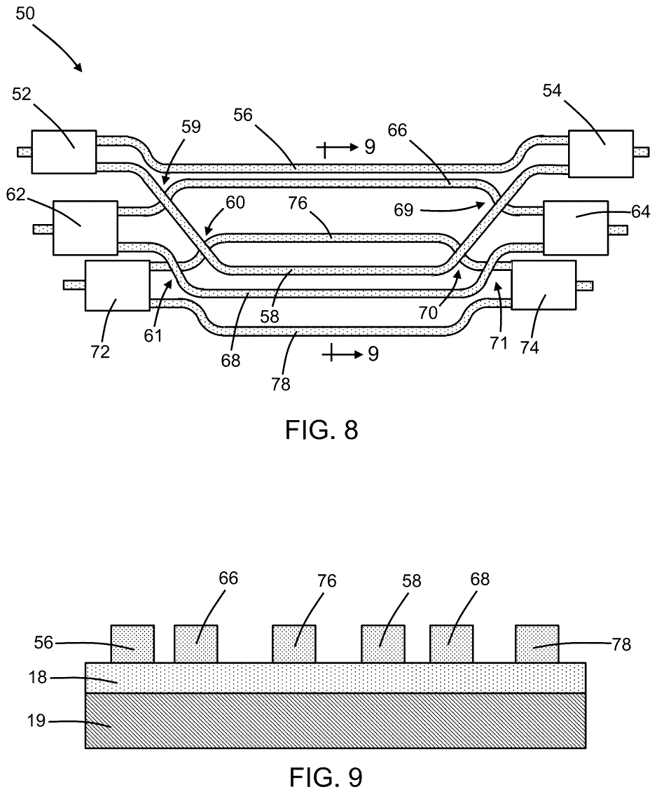

With reference to FIGS. 8, 9 and in accordance with alternative embodiments of the invention, a structure 50 may include a Mach-Zehnder interferometer having an optical coupler 52, an optical coupler 54, and delay arms 56, 58 that extend as separate optical paths between the optical coupler 52 and the optical coupler 54. The structure 50 may also include a Mach-Zehnder interferometer having an optical coupler 62, an optical coupler 64, and delay arms 66, 68 that extend as separate optical paths between the optical coupler 62 and the optical coupler 64. The structure 50 may include a Mach-Zehnder interferometer having an optical coupler 72, an optical coupler 74, and delay arms 76, 78 that extend as separate optical paths between the optical coupler 72 and the optical coupler 74. In an embodiment, the optical couplers 52, 54, the optical couplers 62, 64, and the optical couplers 72, 74 may be multi-mode interference couplers. The delay arms 56, 58, the delay arms 66, 68, and the delay arms 76, 78 may be constructed from waveguide cores similar to the waveguide cores 12, 14, 16.

The delay arms 58 and the delay arm 66 are routed to intersect and cross at a waveguide crossing 59 and at a waveguide crossing 69 spaced from the waveguide crossing 59. The delay arms 58 and the delay arm 76 are routed to intersect and cross at a waveguide crossing 60 and at a waveguide crossing 70 spaced from the waveguide crossing 60. The delay arm 58 and the delay arm 66 are routed to intersect and cross at a waveguide crossing 61 and at a waveguide crossing 71 spaced from the waveguide crossing 61. The routing of the delay arms 56, 66, 76 of the different Mach-Zehnder interferometers enabled by the waveguide crossings 59, 60, 61 and the waveguide crossings 69, 70, 71 places the delay arms 56, 66, 76 as a group in a folded arrangement adjacent to each other. The routing of the delay arms 58, 68, 78 of the different Mach-Zehnder interferometers enabled by the waveguide crossings 59, 60, 61 and the waveguide crossings 69, 70, 71 places the delay arms 58, 68, 78 as a group in a folded arrangement adjacent to each other.

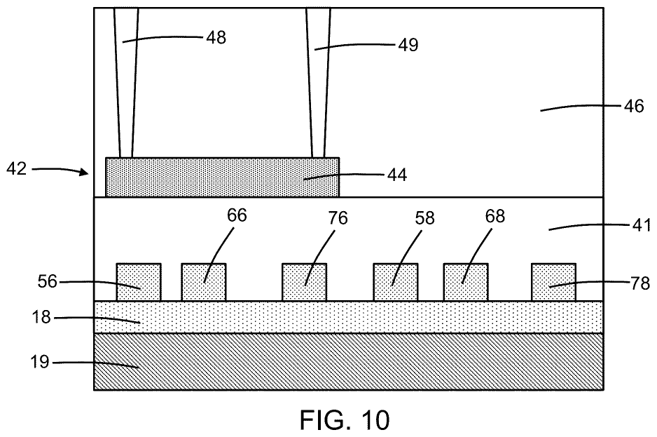

With reference to FIG. 10 and at a fabrication stage subsequent to FIGS. 8, 9, the phase shifter 42 may be formed that is coupled to the adjacent sections of the delay arms 56, 66, 76. More specifically, the resistive heating element 44 overlies, and overlaps with, the adjacent sections of the delay arms 56, 66, 76. The resistive heating element 44 has a non-overlapping relationship with the delay arms 58, 68, 78. The waveguide crossings 59, 60, 61 and the waveguide crossings 69, 70, 71 places the sections of delay arms 56, 66, 76 as a group in adjacency with each other so that the phase shifter 42, in particular the resistive heating element 44, can be commonly coupled to the underlying sections of delay arms 56, 66, 76 and not coupled to the delay arms 58, 68, 78.

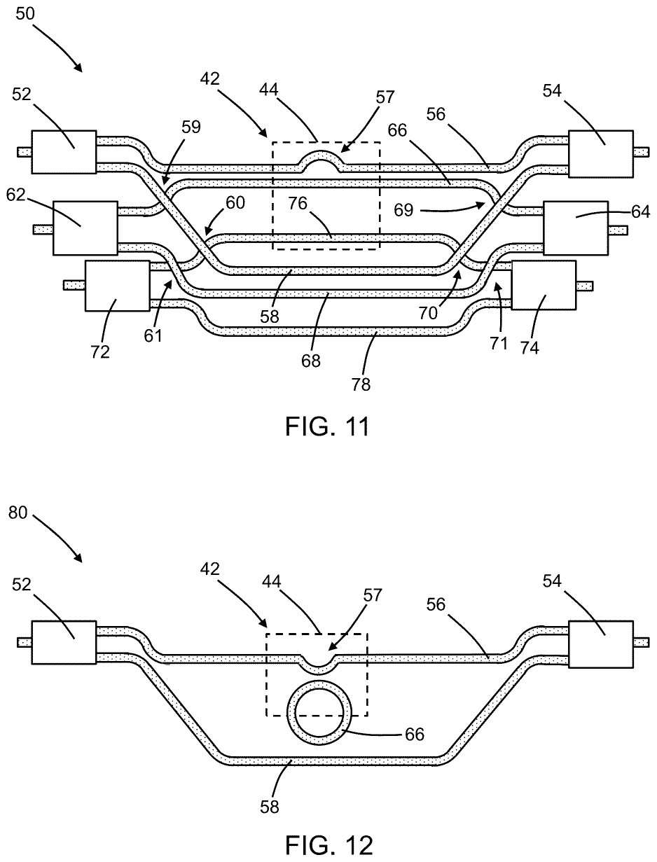

With reference to FIG. 11 and in accordance with alternative embodiments, the delay arm 56 of the structure 50 may include a bend 57 that is included in the section of the delay arm 56 that is overlapped by the subsequently-formed resistive heating element 44 of the phase shifter 42, which in indicated in dashed lines. In alternative embodiments, the delay arm 66 and/or the delay arm 76 may include a bend similar to the bend 57.

With reference to FIG. 12 and in accordance with alternative embodiments, a structure 80 may include the Mach-Zehnder interferometer with the delay arms 56, 58 and a micro-ring resonator 82 that includes a waveguide core 84 that is arranged in the space between the delay arm 56 and the delay arm 58. The subsequently-formed resistive heating element 44 of the phase shifter 42, which in indicated in dashed lines, may overlap with a section of the delay arm 56 that includes the bend 57 and with a portion of the waveguide core 84 of the micro-ring resonator 82. In an embodiment, the waveguide core 84 included in the micro-ring resonator 82 may be characterized by an annular shape with round inner and outer boundaries. In an alternative embodiment, the waveguide core 84 included in the micro-ring resonator 82 may be characterized by a non-round shape, such as a racetrack or oblong shape.

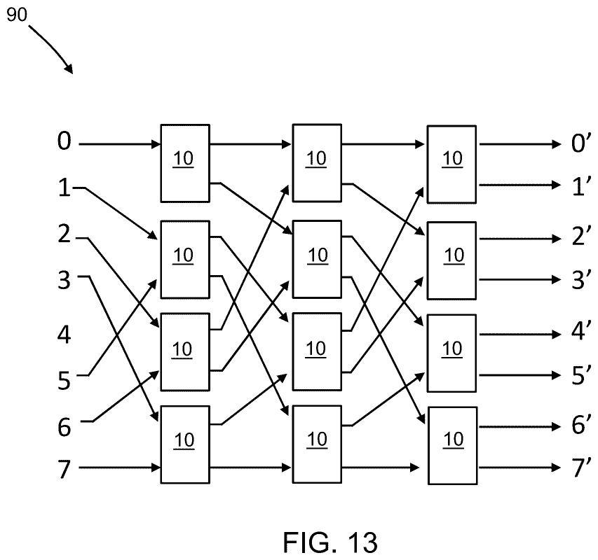

With reference to FIG. 13 and in accordance with alternative embodiments, instances of the structure 10 may be aggregated to form an optical circuit 90 used for a switching application. For example, the instances of the structure 10 may be used to switch optical paths between inputs 0-7 and outputs 0′-7′. Representative optical path switching between inputs 0-7 and outputs 0′-7′ is illustrated by the single-headed arrows. Alternative, instances of the structure 50 may be aggregated to form the optical circuit 90 instead of instances of the structure 10.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a first Mach-Zehnder interferometer including a first delay arm, the first delay arm having a section;
a second Mach-Zehnder interferometer including a second delay arm, the second delay arm having a section adjacent to the section of the first delay arm; and
a phase shifter coupled to the section of the first delay arm of the first Mach-Zehnder interferometer and the section of the second delay arm of the second Mach-Zehnder interferometer.

2. The structure of claim 1 wherein the first Mach-Zehnder interferometer includes a first optical coupler and a second optical coupler, and the first delay arm extends from the first optical coupler to the second optical coupler.

3. The structure of claim 2 wherein the second Mach-Zehnder interferometer includes a third optical coupler and a fourth optical coupler, and the second delay arm extends from the third optical coupler to the fourth optical coupler.

4. The structure of claim 3 wherein the first optical coupler is a first directional coupler, the second optical coupler is a second directional coupler, the third optical coupler is a third directional coupler, and the fourth optical coupler is a fourth directional coupler.

5. The structure of claim 1 wherein the phase shifter includes a resistive heating element that overlaps with the section of the first delay arm of the first Mach-Zehnder interferometer and the section of the second delay arm of the second Mach-Zehnder interferometer.

6. The structure of claim 5 wherein the first Mach-Zehnder interferometer includes a third delay arm, and the resistive heating element has a non-overlapping relationship with the third delay arm.

7. The structure of claim 6 further comprising:
an air gap laterally between the resistive heating element and the third delay arm.

8. The structure of claim 6 wherein the second Mach-Zehnder interferometer includes a fourth delay arm, and the resistive heating element has a non-overlapping relationship with the third delay arm.

9. The structure of claim 8 further comprising:
a first air gap laterally between the resistive heating element and the third delay arm; and
a second air gap laterally between the resistive heating element and the fourth delay arm.

10. The structure of claim 6 wherein the first delay arm and the second delay arm have a folded arrangement.

11. The structure of claim 10 wherein the second delay arm crosses the third delay arm at a waveguide crossing to provide the folded arrangement of the first delay arm and the second delay arm.

12. The structure of claim 1 wherein the first Mach-Zehnder interferometer includes a third delay arm, and the phase shifter is laterally spaced from the third delay arm.

13. The structure of claim 12 wherein the second Mach-Zehnder interferometer includes a fourth delay arm, and the phase shifter is laterally spaced from the fourth delay arm.

14. The structure of claim 1 wherein the section of the first delay arm includes a bend.

15. The structure of claim 1 further comprising:
a semiconductor substrate,
wherein the first delay arm and the second delay arm overlie the semiconductor substrate.

16. The structure of claim 15 wherein the first delay arm is positioned in a vertical direction between the second delay arm and the semiconductor substrate.

17. A structure comprising:
a Mach-Zehnder interferometer including a first delay arm, the first delay arm having a section;
a micro-ring resonator including a waveguide core adjacent to the section of the first delay arm; and
a phase shifter coupled to the section of the first delay arm and a first portion of the waveguide core of the micro-ring resonator.

18. The structure of claim 17 wherein the phase shifter includes a resistive heating element that overlaps with the section of the first delay arm and the first portion of the waveguide core of the micro-ring resonator.

19. The structure of claim 18 wherein the Mach-Zehnder interferometer includes a second delay arm, and the waveguide core of the micro-ring resonator is positioned laterally between the first delay arm and the second delay arm, and the resistive heating element has a non-overlapping relationship with a second portion of the waveguide core of the micro-ring resonator.

20. A method comprising:
forming a first Mach-Zehnder interferometer including a first delay arm;
forming a second Mach-Zehnder interferometer including a second delay arm; and
forming a phase shifter coupled to a section of the first delay arm of the first Mach-Zehnder interferometer and a section of the second delay arm of the second Mach-Zehnder interferometer that is adjacent to the section of the first delay arm.
